(19) United States
(12) Patent Application Publication
(10) Pub. No.: US 2024/0416429 A1
(43) Pub. Date: Dec. 19, 2024

(54) Real-Time Hydraulic Chuck Monitor

(71) Applicant: Kennametal India Ltd., Bangalore (IN)

(72) Inventors: Santhosha Boregowda, Bangalore (IN); Padmakumar Muthuswamy, Bangalore (IN)

(73) Assignee: Kennametal India Ltd., Bangalore (IN)

(21) Appl. No.: 18/747,823

(22) Filed: Jun. 19, 2024

(30) Foreign Application Priority Data
Jun. 19, 2023 (IN) 202341041626

(51) Int. Cl. B23B 31/30

(52) U.S. Cl. CPC B23B 31/30; B23B 2270/48

(57) ABSTRACT

A hydraulic tool holder comprises a body and a piston assembly. The body defines a fluid reservoir adapted to hold a fluid. The piston assembly comprises a piston pin movably arranged within the body and including a first end in communication with the fluid reservoir, and a visual indicator. An elastic element of the piston assembly biases the piston pin toward the fluid reservoir with a predetermined elastic force. The predetermined elastic force is selected such that the visual indicator is visible from an exterior of the body when a pressure of the fluid in the fluid reservoir reaches a predetermined minimum threshold level.

### CROSS-REFERENCE TO RELATED APPLICATION

This application claims the benefit of Indian patent application No. 202341041626 filed on Jun. 19, 2023.

### FIELD OF THE INVENTION

The present disclosure relates tool handling devices, and more specifically, to a hydraulic tool chuck including a pressure monitoring system.

### BACKGROUND

A hydraulic tool chuck or hydraulic tool holder is a device used to secure a tool or a workpiece via the selective application of fluid pressure. When operating a typical hydraulic tool chuck or holder, a user will insert a tool (e.g., a cutting tool) into the holder and selectively increase a pressure of a fluid (e.g., hydraulic oil) held therein for securing the tool. This may be achieved by engaging a clamping element, such as a threaded fastener or clamping screw, into the holder. More specifically, a movable end of the clamping element is in communication with a reservoir of fluid held within the holder. As the clamping element is threaded into the holder and/or the reservoir, the pressure of the fluid held therein is increased. This increase in pressure is operative to, for example, expand a tool bore or sleeve of the holder in a radially inward direction, securing the tool in position within or relative to the holder. Accordingly, a securing force placed on the tool is dependent on the pressure of the fluid held within the fluid reservoir.

Over time, hydraulic tool holders inevitably loose fluid and/or the ability to maintain adequate fluid pressure, creating unsatisfactory operating conditions, including insufficient tool holding torque. This may be the result of, for example, tool and/or holder wear or damage, including the degradation of internal seals. A lack of sufficient tool holding toque can lead to increased tool wear, inaccurate operation of a machine fitted with the tool, or even serious accidents. Current solutions for testing or otherwise determining the health of these holding devices are time consuming, unreliable, costly and/or difficult to implement without significant redesign of the underlying devices.

Accordingly, improved systems and methods for determining the operational health of a hydraulic tool chuck or holder are desired.

### SUMMARY

According to an embodiment of the present disclosure, a hydraulic tool holder includes a fluid chamber or reservoir in communication with an expandable tool bore, a pressure biased indicator, and an elastic element. A portion of the pressure biased indicator is in communication with the fluid chamber, and is movable between a first position, wherein the indicator is not visible from an exterior of the holder, and a second position, wherein the indicator is visible from the exterior of the holder. The elastic element biases the indicator against a pressure applied by fluid within the chamber and toward the first position. As a result, absent sufficient fluid pressure within the fluid chamber to overcome a biasing force of the elastic member, the indicator is not visible, and an operator or user is alerted to the low-pressure or faulty condition.

A piston assembly for a hydraulic chuck or holder according to another embodiment of the present disclosure includes a clamping screw defining a central bore, a piston pin, and a spring or elastic element. The piston pin comprises a first end sized to be received at least partially within the central bore of the clamping screw. The first end is provided with a visual indicator thereon, such as a distinct or highly visible color coating. A second end of the piston pin defines a radial flange. The spring is arranged over the first end of the piston pin and is held between the clamping screw and the radial flange of the piston pin. The central bore, the piston pin and the spring are adapted such that the visual indicator is only visible through the central bore of the clamping screw when the piston pin extends into the central bore by a minimum predetermined distance. The minimum predetermined distance corresponds to the spring being compressed at least to a predetermined minimum length.

A hydraulic tool holder according to another embodiment of the present disclosure comprises a body and a piston assembly. The body defines a fluid chamber or reservoir adapted to hold an incompressible fluid. The piston assembly includes a piston pin movably arranged at least partially within the body. The piston pin has a first end in communication with the fluid chamber. An elastic element of the piston assembly biases the piston pin into or toward the fluid chamber with a predetermined elastic force. The predetermined elastic force is selected such that a portion of the piston pin is visible from an exterior of the body only after a pressure of the fluid held in the fluid chamber reaches a predetermined non-zero threshold level.

### BRIEF DESCRIPTION OF THE DRAWINGS

The invention will now be described by way of example with reference to the accompanying Figures, of which:

FIG. 1 is a side perspective view of a hydraulic tool chuck or holder according to an embodiment of the present disclosure;

FIG. 2 is a partial cross-sectional view of the hydraulic tool chuck or holder of FIG. 1;

FIG. 3 is a side perspective view of a piston pin of the hydraulic tool chuck or holder of FIG. 2;

FIG. 4 is a side view of a piston assembly of the hydraulic tool chuck or holder of the preceding figures;

FIG. 5 is a partial cross-sectional view of the tool chuck or holder of the preceding figures in a first state associated with an adequate internal fluid pressure;

FIG. 6 is a partial cross-sectional view of the tool chuck or holder of the preceding figures in a second state associated with an inadequate internal fluid pressure; and

FIG. 7 is a partial side view illustrating the tool chuck or holder of the preceding figures in the first state, wherein a visual indicator thereof is visible to a user from a vantage point external to the tool chuck or holder.

FIG. 8 is a partial cross-sectional view of and alternate hydraulic tool chuck or holder.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Embodiments of the present disclosure safeguard against the above-described unsafe operating conditions of a failed hydraulic holder by providing a visual indication to a user or operator that a predetermined internal fluid pressure has been reached at the time of securing the tool or workpiece to the holder. More specifically, embodiments of the present disclosure include a pressure monitoring system including a spring and pressure biased visual indicator associated with a movable piston pin. The piston pin and a biasing spring are installed within a body of the holder and are retained therein via a clamping fastener or screw, similar to those used in holders of the prior art. The piston pin is biased into fluid communication with an internal fluid reservoir of the body. Given the proper selection of the spring used to bias the piston pin, the visual indicator is adapted to be visible to the user only if adequate fluid pressure is present within the reservoir. If the indicator is not visible once the tool is believed to be secured, however, the user is alerted to a failed or inadequately pressurized holder, and may seek replacement or repair before use. In this way, embodiments of the present disclosure provide a real-time indicator of adequate fluid pressure, and thus tool holding torque, each time the hydraulic chuck or holder is clamped. The pressure monitoring system remains functional during use, such that a failure of the tool holder mid-operation may also be detected in real-time via periodic visual inspection.

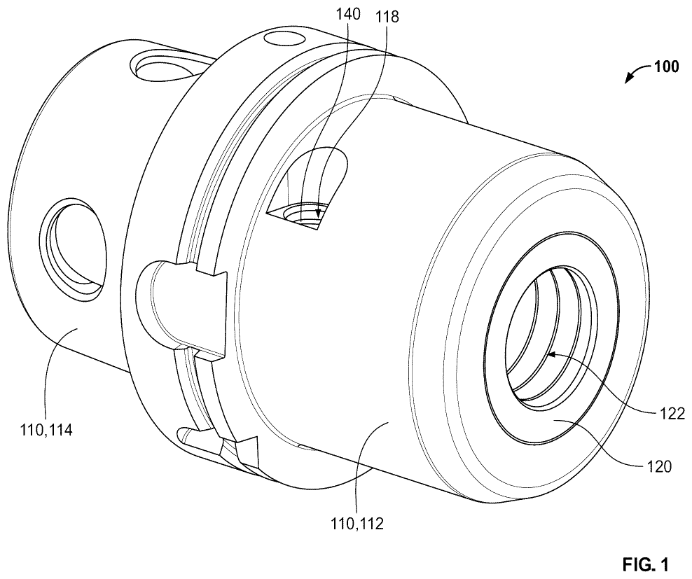

Referring generally to FIG. 1, embodiments of the present disclosure will be described in the context of an exemplary hydraulic tool chuck, holder or device 100. The device 100 includes a body 110 having a first end 112 defining an opening or bore into which a tool (e.g., a drill bit, end mill, etc.) is inserted, and a second end 114 adapted to be received by, for example, a machine (e.g., a drill press, milling machine, lathe or the like). An expandable tool sleeve 120 may be provided within the body 110 for selectively holding the tool within an open bore or chamber 122 thereof. The sleeve 120 may be formed integrally with the body 110, or may comprise a separate element installed therein, as would be understood by one of ordinary skill in the art. The body 110 further includes an at least partially threaded bore 118 receiving a clamping screw 140 of a pressure monitoring system according to an embodiment of the present disclosure. Like holders of the prior art, the clamping screw 140 is adapted to selectively increase the pressure of a fluid retained within the device 100, resulting in the expansion of the sleeve 120 for securing the tool therein.

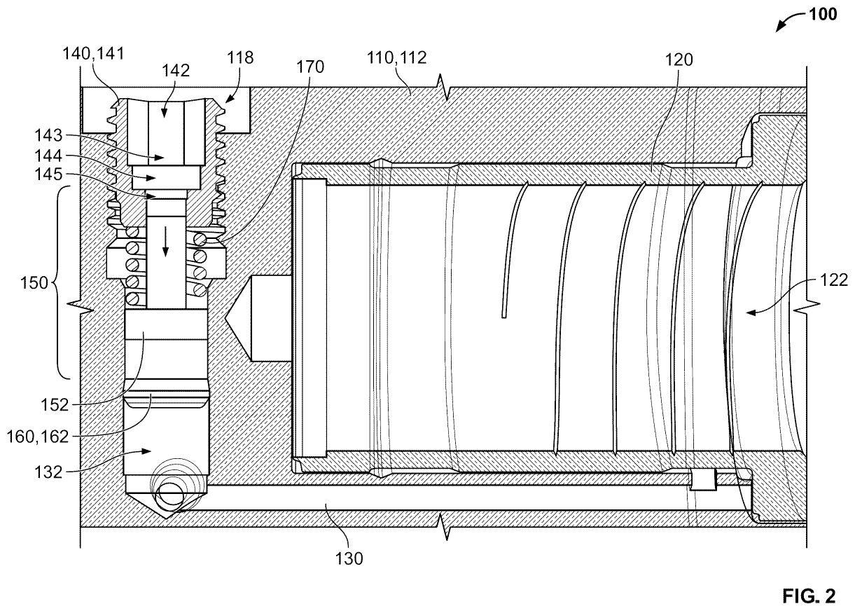

Referring now to FIG. 2, a simplified cross-sectional view of the device 100 is provided. The expandable sleeve 120 is arranged within the body 110 and is at least partially surrounded by pressurized fluid provided via one or more fluid passages 130. More specifically, the fluid passages 130 may form part of, or be in communication with, a system of chambers or a hydraulic bladder which at least partially surrounds the sleeve 120. The fluid passages 130 are in communication with a fluid reservoir 132, which is in turn in communication with a movable piston assembly or pressure biased indicator 150 arranged within the bore 118 of the body 110.

The piston assembly 150 is held within the bore 118 via the clamping screw 140, and generally includes a movable piston pin 152, a seal or sealing end 160, and an elastic element or elastomer, representatively embodied as a spring 170. The exemplary clamping screw 140 is embodied as a hollow set screw having an external threading 141 and an inner central bore 142 extending therethrough. An upper portion 143 of the inner bore 142 may define a female socket (e.g., a hex key socket) formed at least partially into the screw 140 from a first end thereof to a predetermined depth. An intermediate portion 144 of the inner bore 142 is arranged below the upper portion 143 and defines a circumferential dimension or diameter that is less than that of the upper portion, thus limiting an insertion depth of a tool used to selectively rotate the screw 140. A lower portion 145 of the inner bore 142 defines a generally cylindrical guide bore sized to slidably receive an end of the piston pin 152 therein. The spring 170 is held between the piston pin 152 and an axially facing end 148 of the clamping screw 140 (see FIG. 4, for example). The spring 170 is operative to bias the piston pin 152 in an axial direction toward or into the fluid reservoir 132 (i.e., downward in the illustrated orientation).

Still referring to FIG. 2, the seal 160 is provided on a side of the piston pin 152 opposite the spring 170, and is adapted to form a seal with the bore 118 of the tool body 110, thus isolating the piston pin 152 from the fluid reservoir 132. The seal 160 may define at least one radially outward extending annular sealing rib or protrusion 162, and may be formed from a flexible or compressible polymer material, by way of example. The seal 160 may be formed integrally with a remainder of the piston pin 152, or may comprise a discrete element secured thereto.

As can be visualized from FIG. 2, threading the clamping screw 140 into the bore 118 is operative to bias the piston assembly 150 into the body 110 such that a free end thereof (i.e., the seal 160) acts on the fluid held within the reservoir 132, and thus the passages 130. In FIG. 2, the clamping screw 140 is in a generally retracted position within the bore 118 such that little to no excess force is applied on the fluid held in the reservoir 132 by the piston pin 152. In this open position of the device 100, a tool is free to be inserted or installed into (or removed from) the bore 122 of the sleeve 120. After a tool has been installed within the sleeve 120, the clamping screw 140 may be further threaded into the body 110, increasing the pressure of the fluid within the reservoir 132 and passages 130. This action is operative to expand the sleeve 120 in a radially inward direction for securing the tool within the bore 122.

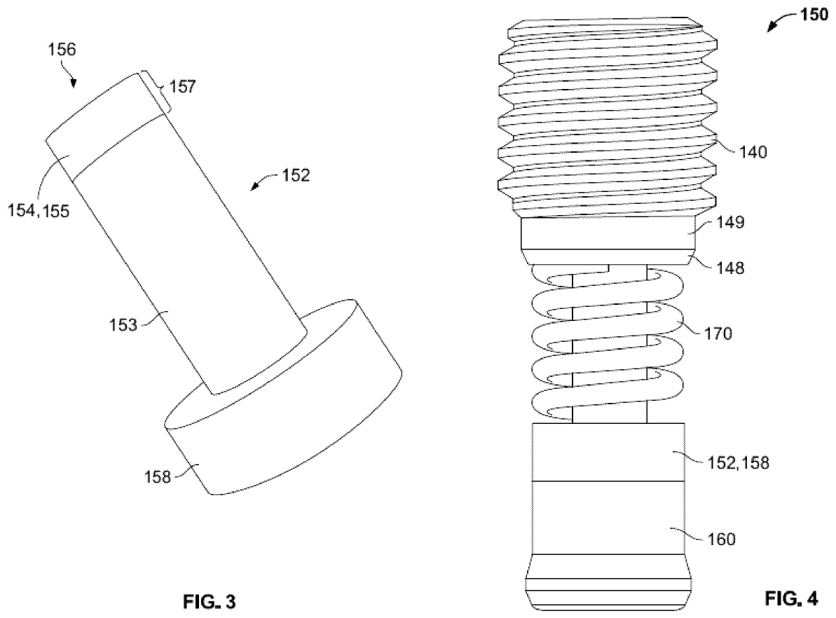

Referring now to FIG. 3, the movable piston pin 152 includes a cylindrical main body 153 having a first end defining a visual indicator 154, and a second end defining a radially outward extending flange 158. The visual indicator 154 may be a coating 155 having a color (e.g., green, yellow, or other bright, easily visible color) distinct from that of a remainder of the piston pin 152. The color coating 155 may be applied to an axial end face 156 of the main body 153, and/or at least partially down a circumferential outer surface 157 of the main body in an axial direction. In other embodiments, the visual indicator 154 may be defined only as the free end of the main body 153 and may be the same color as a remainder of the piston pin 152.

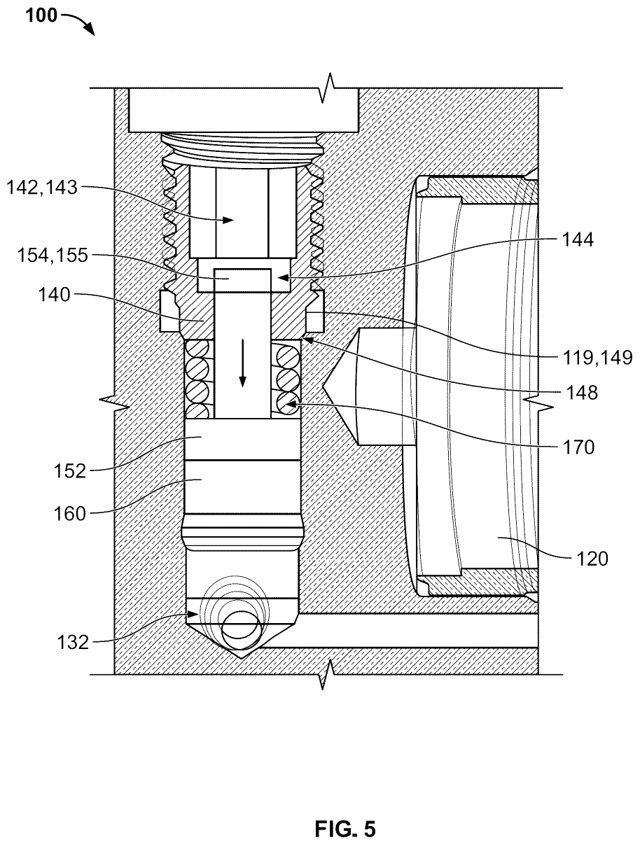

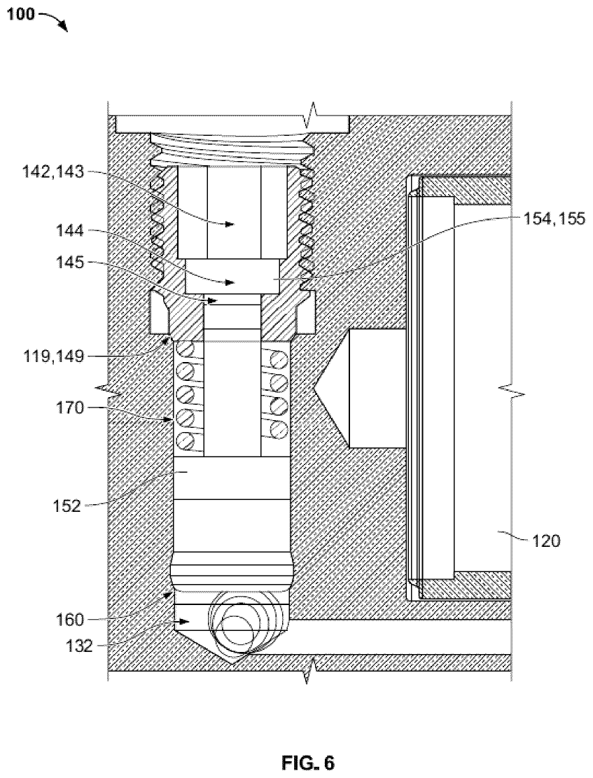

FIG. 4 illustrates the piston assembly 150 prior to its installation into the body 110 of the device 100. As shown, the flange 158 of the piston pin 152 is adapted (i.e., sized and shaped) to form a spring seat on a first side thereof for supporting the spring 170. An opposite end of the spring 170 abuts the opposing axially facing end 148 of the clamping screw 140. A lower exterior portion of the clamping screw 140 defines a bearing or stop surface 149 corresponding in shape to an opposing inner surface 119 of the bore 118. See FIGS. 5 and 6. The opposing surfaces 119, 149 define a mechanical stop, limiting a threaded insertion depth of the screw 140 into the body 110.

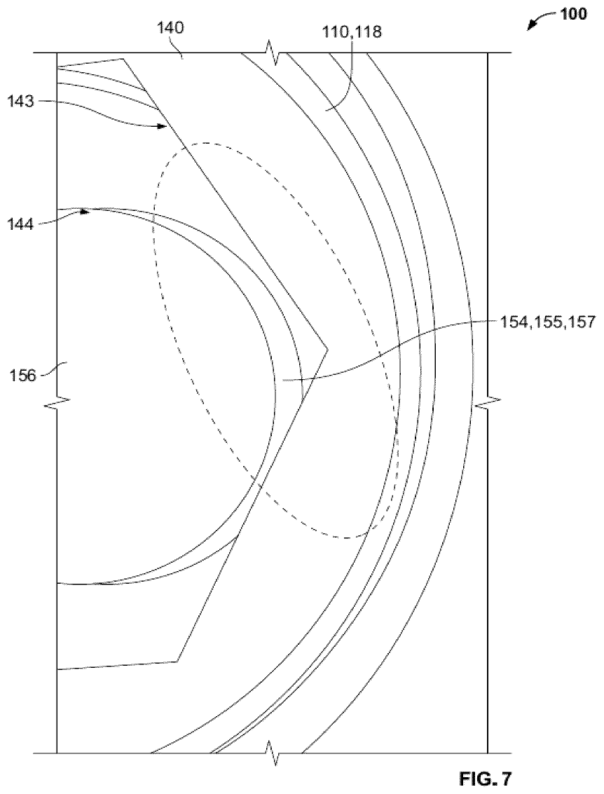

Still referring to FIGS. 5 and 6, the device 100 is shown with the piston assembly 150 in a first position or state, wherein it visually indicates sufficient internal fluid pressure to a user (FIG. 5), and a second position or state, wherein the assembly does not visually indicate sufficient internal fluid pressure to the user (FIG. 6). More specifically, as shown in FIG. 5, after a tool has been inserted into the bore 122 of the sleeve 120, a user will begin to tighten the clamping screw 140 within the body 110. As the clamping screw 140 is threaded toward a fully seated position (i.e., wherein the opposing surfaces 119, 149 thereof abut one another), a pressure of the fluid held within the reservoir 132 is increased. As this internal fluid pressure is increased to at least a predetermined minimum level, it acts on the seal 160 of the piston assembly 150, urging the piston pin 152 vertically upward and compressing the spring 170 against the opposing end face 148 of the clamping screw 140. At the same time, the visual indicator 154 of the piston pin 152 is biased sufficiently vertically upward such that it extends axially outwardly from the lower portion 145 of the inner bore 142, and protrudes into the intermediate portion 144 thereof. In this state or position, the visual indicator 154 or color coating 155 of the piston pin 152 is at least partially visible to a user or operator through the upper portion 143 of inner bore 142 of the clamping screw 140, as shown in FIG. 7. In this way, from an external vantage point relative to the device 100, a user is provided with a visual indication of adequate internal fluid pressure, and thus tool holding torque, of the device.

In the alternative, as show in FIG. 6, if sufficient fluid pressure with the fluid reservoir 132 is not generated with the clamping screw 140 in the fully seated position, the spring 170 is not compressed sufficiently enough to bias the visual indicator 154 of the piston pin 152 from within the lower portion 145 of the inner bore 142. In this way, the visual indicator 154 will not be visible to a user, thus alerting the user to an unsafe low-pressure condition and/or to a faulty device 100. In one particular embodiment, as shown in FIG. 7, the axial end face 156 of the piston pin 152 is free from the color coating 155 of the visual indicator 154. In this way, the end face 156 will not be visible (or easily visible) through the bore 142 of the clamping screw 140 while the visual indicator 154 remains in the lower portion 145. With the color coating 155 arranged only on the circumferential outer surface 157 of the piston pin 152, it becomes visible only upon this surface protruding into the expanded intermediate portion 144 of the inner bore 142.

While the visual indicator 154 has been described herein as a color coating, in other embodiments, the indicator may be a mechanical feature such as a detent, protrusion or other visually distinguishable feature of the piston pin 152. For example, in some embodiments, the free end of the piston pin 152, even if uncolored relative to a remainder thereof, may be visually identified once it extends into the intermediate portion 144 of the inner bore 142. While the visual indicator 154 has been described herein as defined by a part of the movably piston pin 152, it should be understood that it may also be a separate component attached to or otherwise associated with the piston pin 152.

Further, while embodiments of the present disclosure have been described in the context of an exemplary hydraulic tool holder, the piston assembly 150 described herein may be implemented into other forms of hydraulically biased workpiece and/or tool holders without departing from the scope of the present disclosure.

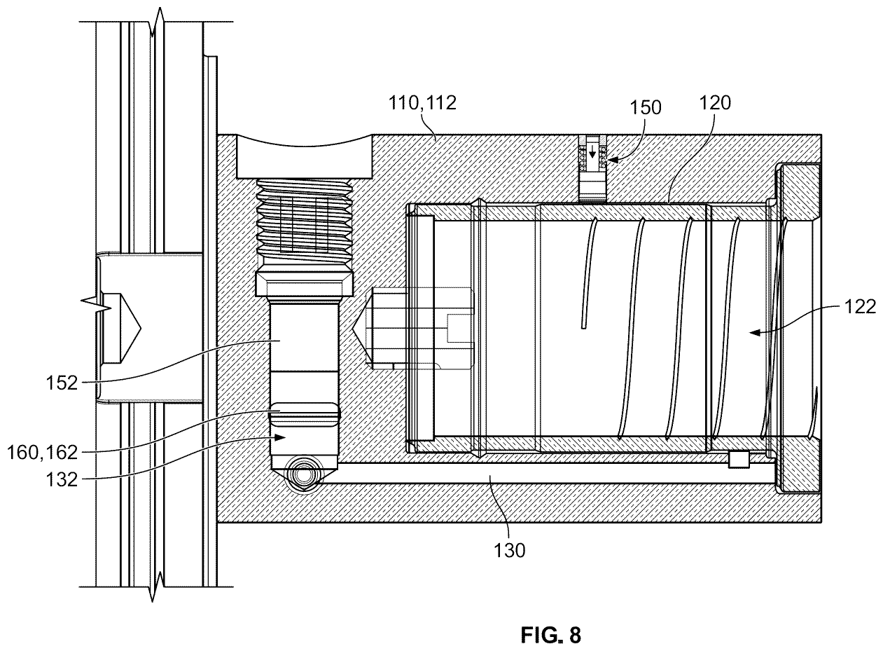

In the alternative, as show in FIG. 8, the piston assembly 150 may be located in another area of the body 110 of the tool chuck, holder or device 100 and separated from the threaded bore 118. As shown here, for example, the piston assembly 150 may be located such that the seal 160 is in contact with the expandable tool sleeve 120. As the internal fluid pressure is increased to at least a predetermined minimum level, it acts on the expandable tool sleeve 120 and seal 160 of the piston assembly 150, urging the piston pin 152 vertically upward and compressing the spring 170 against the opposing end face 148 of the clamping screw 140. At the same time, the visual indicator 154 of the piston pin 152 is biased sufficiently vertically upward such that it extends axially outwardly from the body 110, and protrudes such that the visual indicator 154 becomes visible thus indicating sufficient fluid pressure and expansion of the expandable tool sleeve 120.

It should be understood that the functionality of the above-described pressure monitoring system is dependent upon the proper selection of the elastic element or spring 170 for a given size piston area. Specifically, the spring 170 has a spring rate selected to ensure that the visual indicator 154 is only biased into the intermediate portion 144 of the bore 142 after a predetermined internal fluid pressure is achieved. A spring having suitable characteristic may be selected using the following method(s).

First, a determination is made of an axial force (F) applied by the clamping screw 140 in order to clamp the tool. This force may be derived from a known relationship with applied torque (i.e., torque applied to the clamping screw 140 to secure the tool, e.g., 10-15 Nm). Specifically:

$$T = KFd ( 1 - L / 100 )$$

wherein,
T=wrench torque (Nm)
K=constant that depends on the screw material and size
d=nominal bolt or screw diameter (m)
F=axial bolt force (N)
L=lubrication factor (%)

From a calculated axial force (F), a suitable wire diameter (d) of a coil spring may be determined according to the relationship:

$${d}^{4} = 8 {FD}^{3} i / GY$$

wherein,
D=mean spring diameter (mm)
F=axial force (N)
i=number of active coils
G=modulus of rigidity
Y=deflection (mm)

Utilizing the above relationships, a spring may be selected which provides a desired solid length (i.e., a fully compressed length) for a predetermined amount of axial force, thus ensuring that the spring is only fully compressed, and the visual indicator only revealed or visible within the bore of the clamping screw, after sufficient axial force is applied on the piston pin by the fluid held within the reservoir. Further, as set forth above, the elastic element is not limited to a spring. For example, an elastomer or elastomeric material may be implemented for performing the described function without departing from the scope of the present disclosure. Selection of the elastomer (e.g., material, density, etc.) may be made in accordance with the above-described design criteria.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A hydraulic tool holder, comprising:
a body defining a fluid reservoir adapted to hold a fluid; and
a piston assembly, including:
a piston pin movably arranged within the body and including a first end in communication with the fluid reservoir;
a visual indicator associated with the piston pin; and
an elastic element biasing the piston pin toward the fluid reservoir with a predetermined elastic force, the predetermined elastic force selected such that the visual indicator is biased into a first position visible from an exterior of the body when a pressure of the fluid in the fluid reservoir reaches a predetermined minimum threshold level.

2. The tool holder of claim 1, wherein the predetermined elastic force is selected such that the visual indicator is not visible from the exterior of the body when the pressure of the fluid within the fluid reservoir is below the predetermined minimum threshold level.

3. The tool holder of claim 2, wherein the body further comprises:
a tool sleeve adapted to expand radially inward under a force exerted by the fluid within the fluid reservoir; and
a piston assembly opening formed into the body and receiving the piston assembly.

4. The tool holder of claim 3, further comprising a clamping screw threadably engaged with the piston assembly opening and retaining the piston assembly within the piston assembly opening, the clamping screw defining a central bore extending therethrough.

5. The tool holder of claim 4, wherein a second end of the piston pin defines the visual indicator and is at least partially received within the central bore of the clamping screw.

6. The tool holder of claim 5, wherein the elastic element comprises a spring arranged between the clamping screw and an opposing surface of the piston pin.

7. The tool holder of claim 6, wherein, with the clamping screw is threadably engaged within the piston assembly opening to a predetermined depth or tightened to a predetermined torque, a compressive force acting on the spring is indicative of the pressure of the fluid in the fluid reservoir.

8. The tool holder of claim 7, wherein:
with the pressure of the fluid in the fluid reservoir below the predetermined threshold level, the visual indicator of the piston assembly is not visible though the central bore of the clamping screw; and
with the pressure of the fluid in the fluid reservoir greater than or equal to the predetermined threshold level, the visual indicator of the piston assembly is visible though the central bore of the clamping screw.

9. The tool holder of claim 7, wherein the piston assembly opening defines a clamping screw seat limiting an insertion depth of the clamping screw into the opening.

10. The tool holder of claim 5, wherein the central bore of the clamping screw includes:
an upper portion defining a tool mating surface adapted to engage with a tool for rotating the screw; and
a lower portion having a diameter corresponding to, and forming a sliding fit with, the second end of piston pin.

11. The tool holder of claim 10, wherein the central bore of the clamping screw further includes an intermediate portion arranged between the upper portion and the lower portion, the intermediate portion having a diameter greater than the lower portion.

12. The tool holder of claim 11, wherein the visual indicator projects into the intermediate portion of the central bore in the first position.

13. The tool holder of claim 12, wherein the visual indicator remains in the lower portion of the central bore when the pressure of the fluid within the fluid reservoir is below the predetermined threshold level.

14. The tool holder of claim 12, wherein the visual indicator has a color distinct from that of the piston pin and the clamping screw.

15. A piston assembly for a hydraulic tool holder, comprising:
a clamping screw defining a central bore;
a piston pin, including:
a first end sized to be received at least partially within the central bore of the clamping screw;
a visual indicator associated with the first end of the piston pin; and
a second end defining a radial flange; and
a spring arranged between the clamping screw and the radial flange of the piston pin.

16. The piston assembly of claim 15, wherein the visual indicator of the piston pin is visible through the central bore of the clamping screw with the spring compressed to a predetermined height.

17. The piston assembly of claim 15, further comprising a seal arranged on a side of the radial flange of the piston pin opposite the spring.

18. The piston assembly of claim 15, wherein the visual indication has a color distinct from that of the piston pin and the clamping screw.

19. A hydraulic tool holder, comprising:
a body defining a fluid chamber in communication with an expandable tool sleeve;
a pressure biased visual indicator in communication with the fluid chamber, the visual indicator movable between a first position visible to a user, and a second position not visible to a user; and
an elastic element biasing the visual indicator against a pressure applied by fluid within the fluid chamber and in a direction of the second position.

20. The tool holder of claim 19, wherein a spring rate of the elastic element is selected such that:
with the pressure of the fluid in the fluid chamber below a predetermined level, the visual indicator is biased into the second position by the elastic element; and
with the pressure of the fluid in the fluid chamber equal to or greater than the predetermined level, the elastic element is compressed by the fluid and the visual indicator is biased into the first position.

21. A hydraulic tool holder, comprising:
a body having a fluid chamber in communication with an expandable tool sleeve;
a pressure biased visual indicator in communication with the expandable tool sleeve, the visual indicator movable between a first position visible to a user, and a second position not visible to a user; and
an elastic element biasing the visual indicator against the expandable tool sleeve and in a direction of the second position.
